(19) United States
(12) Patent Application Publication
(10) Pub. No.: US 2020/0394671 A1
(43) Pub. Date: Dec. 17, 2020

(54) APPARATUS AND METHOD FOR TOKENIZED PEER RECOGNITION FACTORING-IN SOCIAL BEHAVIOR

(71) Applicant: BIGDATA TEKNOLOJI A.S., Beykoz Istanbul (TR)

(72) Inventors: EROZAN KURTAS, ISTANBUL (TR); BULENT OZEL, AMSTERDAM (NL)

(21) Appl. No.: 16/904,487

(22) Filed: Jun. 17, 2020

Related U.S. Application Data
(60) Provisional application No. 62/921,425, filed on Jun. 17, 2019.

(51) Int. Cl. G06Q 30/02; G06Q 10/10; G06Q 20/36; G06Q 50/00; G06Q 10/06; G06Q 40/04; G06F 16/23

(52) U.S. Cl. CPC G06Q 30/0216; G06Q 10/105; G06Q 20/3672; G06Q 50/01; G06Q 2220/00; G06Q 10/06395; G06Q 40/04; G06F 16/2379; G06Q 10/06398

(57) ABSTRACT

An intra-corporate tokenized recognition system and method are developed by which the employees can send to their co-workers, tokens to show appreciation. One key aspect of this invention is factoring-in the social behavior during token transactions using a social network graph. Doing so, a weight (or significance) is assigned to each token transaction and used a multiplier of the number of the tokens, while maintaining transaction auditability, immutability, publicity and anonymity. The aforementioned weight is determined by a software component penalizing social anomalies such as cliques and dyads. This invention integrates a weighted social network graph representing employee token transactions with a blockchain.

### RELATED APPLICATION

This application claims the benefit of provisional application 62/921,425 filed Jun. 17, 2019.

### BACKGROUND OF THE INVENTION

### Field of Invention

The present invention relates to people analytics, a blockchain, databases, a distributed ledger and social networking algorithms, and its embodiments are for the use of human resources organization and members of a corporation.

### Discussion of Related Art

Any discussion of the prior art throughout the specification should in no way be considered as an admission that such prior art is widely known or forms part of common general knowledge in the field.

Recent research shows that even in today's highly competitive environment, many organizations are reluctant to provide higher salaries, but instead extend comprehensive non-cash reward programs to their employees. Corporations are now offering highly flexible work hours, free meals, free transportation, unlimited vacation time, cacheable points, etc. as rewards as opposed to cash. This philosophy would indeed better serve organizations to meet their financial targets. It also means that a broader view of employee recognition is becoming even more important than ever as organizations that look to finding more effective ways to motivate employees. A recent comprehensive survey in the United States has shown that for employees “the nature of the work” (not the pay) came in first, followed by “the ability to learn new skills and progress”. This shift from monetary rewards to work experience and recognition is becoming critical to creating a workforce experience that stands out as a differentiator in attracting and retaining highly-talented workers.

Many different reward and recognition programs are certainly available in prior art, wherein many start by analyzing company needs, and then structuring programs accordingly. Some of these programs that are closest to this invention provide employee ‘reward points’ that are redeemable to cash, stock options, stock or services, or to a general category of benefits that make the workplace more attractive.

The present invention provides a new recognition system that is reliant on simple token exchanges mechanism between employees, wherein the number of tokens accumulated by each employee is a sign of peer recognition and accomplishment. Each token exchange transaction is immediate and without any company overhead (such as approvals or budget constraints). Given employee recognition is more about motivating employees, these tokens do not need to be redeemed to any other benefit.

In this invention, the reward and recognition method that comprises a token exchange process between employees is modeled using a blockchain system (many forms are readily available as open source or commercial software), wherein a token is fungible and tradable, but one that doesn't hold any financial value such as bitcoin. Token transactions occur between employees on the blockchain platform or a database, and each token transfer (or transaction) is recorded on a company-specific ledger. Furthermore, the token transactions are tied to an electronic smart contract, a self-executing code, that need no third party to operate. The smart contract is configured according to specific policies of the company. Each user is provided a simple ‘Employee Client Application’ (ECA) that manages employee's wallet and token transfers. While token exchanges occur, the social networking behavior of token exchanges between employees is recorded, and used as a factor in the number of tokens transferred in each transaction.

It works as follows: an electronic employee wallet to hold tokens is created by ECA for each participating employee. Then, a company wallet creates a finite number of tokens for the reward and recognition program and distributes them to all electronic employee wallets according to company policies. For example, a manager may get more tokens than a non-management employee, a vice president may get more tokens than a director, and so on. From time to time, some number of tokens are transferred from one employee to his/her co-worker(s), while each trade (or transaction) is weighted by a factor derived from the social networking behavior of the sender and receiver, and the company policies. The transaction is recorded on a distributed ledger. Furthermore, the tokens are tied to a so-called smart contract, a self-executing code, that ties into these companies' policies, as well as the evolving social networking graph and a weight calculator. The smart contract extracts the weight of the transaction from a software component that continuously calculates, and updates transaction weights based on the evolving social networking graph as transactions occur.

In the first embodiment, employees only trade tokens previously received from the company wallet. Once a token is received from another employee, it is no longer tradable.

In the second embodiment, the employees are allowed to exchange tokens received from other employees in return for work or project help. The received token through this process may or may not be treated differently than those tokens received according to first embodiment.

In a third embodiment, an employee can send a negative token symbolizing a ‘penalty’ as opposed to a reward. The negative token decrements the total number of tokens in the wallet received.

Token exchange in all above embodiments brings several key advantages:
Full transparency since each employee has the visibility of token transactions and each wallet.
Immutability of the ledger, meaning each transaction is perfectly auditable.

The transaction activity cannot be forged or manipulated.
Instant execute-ability of a reward transaction, i.e., without requiring any administrative intervention or process.
High security provided inherently by cryptography.

Blockchain is a distributed transaction database among multiple computing devices and well known in prior art. A blockchain is formed from so-called blocks; with each block having information related to a transaction and linking it to a prior block in the chain. The computing devices can each have copies of the blockchain as new blocks are generated, so that no centralized or official copy of the blockchain exists and no computing device is trusted more than any other computing device. A public blockchain allows anyone to join the blockchain network, meaning that they can read, write, or participate. On the other hand, a private blockchain is a permission-based blockchain. Permissioned networks place restrictions on who is allowed to participate and in what transactions. The employee recognition program of this invention uses a private blockchain that is implemented within a company but can use public blockchain as well.

The data in the blockchain is called ‘immutable’, meaning it is impossible to alter. Written once, the information in a block cannot be edited, thus it is essentially ‘read only’. Once created, the transaction record can no longer be edited or deleted. This makes them immutable and historically very accurate. You can think of it as an ever-growing journal that is having new pages added to it over time. Furthermore, blockchain is secured by highly complex mathematics and distributed making it practically impossible to manipulate. The blockchain database is different from conventional databases, where data is housed in a certain data structure (like arrays or tables) and controlled through a centralized administration function that is given to an administrative user. This approach opens up the whole system to the end user. In contrast, the blocks in a blockchain are simply a list of transactions as records. The major difference, however, is that blocks are linked (each block contains the hash of the previous block) and each transaction references the transaction output of the previous transaction. In some way, this acts like a foreign key. What is stored in that block/transaction is up to the specific application using blockchain. However, it is able to do more than a normal database that acts as a ledger because it can also provide various “services”. For example, it can be associated with so called “Smart Contracts” that can perform certain tasks related to transactions.

In addition to blockchain technology, several embodiments of this invention use concepts of social networks. Social networks have become increasingly popular in recent years with applications such as FACEBOOK©, LINKEDIN© and INSTAGRAM©, attracting millions of users across the globe, wherein each user is networked with other users either through friendship or professional associations. The resulting graph representing the social network of these millions of users have millions of vertices (users or actors) and edges (social associations). Research has recently exploded on social networks to understand their structure, and their use such as for advertising and marketing. As a result, companies that are hosting a social networking graph are publishing portions of the graphs so that independent entities can analyze and perform research on it. In prior art, there has also been considerable interest in the analysis of the weighted graph model in which the social network is modeled. The weighted graph model is used for analyzing the formation of communities within the network, modeling the structure and dynamics such as opinion formation, and for analysis of the speed of spread of information through the social links.

The semantics of the edge weights depend on the specific application such as users in a social network assigning weights based on “degree of friendship”, “trustworthiness”, “behavior”, frequency of transaction, etc. Second, even in the case where the node (token donating employee, in our case) identities are kept completely anonymous, the solution to the problem of determining the ‘edge weight’ must be extractable. The objective is to construct a model that correctly captures the proper weight for each token transaction between two wallets. The goal is to capture the dynamic behavior of the token transactions and the associated social dynamics using an algorithm. The edge weight (or simply weight) is determined by a simple algorithm wherein the company policies and general topological anomalies (when observed) are used as a set of “rules” used in incrementing or decrementing a current transaction's weight (or importance). Thus, the weight assignment may be modeled differently in different companies. Mathematically speaking, the weighted graph is G=(V, E, W), where V are the set of nodes (employees), and E is the set of edges (token transactions), the set W is the set of weights associated with each edge, where G is a dynamic, time-varying and evolving graph, more accurately represented as G(t)=(V(t), E(t), W(t)).

One of the social behaviors that may affect edge weights is so called the clique-ness. The idea of a clique in a social graph is relatively simple. At the most general level, a clique is a sub-set of a network in which the actors are more closely and intensely tied to one another than they are to other members of the network by frequent token exchanges. In terms of friendship ties, for example, it is not unusual for people in such groups to form cliques on the basis of organization, project group, job definition, gender, race, ethnicity, religion/ideology, and many other things. The smallest clique is composed of two actors: the dyad. A number of approaches to finding groups in graphs are developed in prior art to determine cliques and dyads, and thus will not be recited here.

In one simple embodiment, the weight of a token exchange is determined using a composite of values and their associated weights using a simple exemplary function:

Wᵢⱼ(t)=1−f(w₁aᵢⱼ,w₂bᵢ,w₃dⱼ) (1)

Wᵢⱼ (t) is the token transaction weight between node (employee) i and j at time t, where t is time of exchange, and −1≤w₁, w₂, w₃≤1, and f(⋅) is function, where

0≤Wᵢⱼ(t)≤1 (2)
w_{1,2,3} are relative weights,
aᵢⱼ is an edge-value associated with the edge between node i and node j (this is derived from metrics measuring clique-ness, friendship, traversal of cross-organization boundaries, etc.)
bᵢ is a node-value associated with the token giver (this can be a value given to the rank or status of the token giver, etc.)—only applicable if the token giver chooses not to stay anonymous.
dⱼ is a node-value associated with the token receiver (this can be a value given to the rank or status of the token receiver, etc.).

Weights w_{1,2,3} and the type of function ƒ(⋅) used are adjusted according to company policies/rules and as the social networking graph evolves. It is important to note that Wᵢⱼ (t) is a minor corrective factor. It is mainly intended to discourage social behavior that is not conducive to genuine appreciation for good work. When an employee recognizes that his/her transaction of 1 token to a co-worker is accepted as only 0.8 token, that would raise a flag on the ‘social quality and acceptance level’ of that transaction as perceived by the system. However, this weight should not be overpowering a token transaction by grossly altering the token givers intentions. The default weight is always 1 (one).

Weights are time varying, meaning their values change in time as the graph evolves. The main goal is to reduce the effects of possible anomalies such as favoritisms in token-transactions between employees (intra-project or intra-group favoritism), friendship, and other types of social behavior irrelevant to performance within the organization. This model also incorporates the value of a token giver, and the relative position of the token receiver to the giver (for example a token receiver in another organization or group may be more valuable compared to immediate project group).

Embodiments of the present invention are an improvement over prior art systems and methods.

### SUMMARY OF THE INVENTION

In one embodiment, the present invention provides a method comprising: (a) receiving a token transaction request to transfer one or more tokens from a first wallet associated with a first employee of a company to a second wallet associated with a second employee of the company; (b) processing the token transaction request of (a), the processing comprising: (i) determining a weight associated with the one or more tokens to be transferred; (ii) determining a weighted set of tokens based on the determined weight in (b)(i) and the one or more tokens of (a); (c) decrementing the first wallet by the weighted set of tokens determined in (b)(ii) and incrementing the second wallet by the weighted set of tokens determined in (b)(ii); wherein the token transaction request is issued to recognize accomplishment of the second employee by the first employee.

In another embodiment, the present invention provides a method comprising: (a) receiving a token transaction request to transfer one or more tokens from a first wallet associated with a first employee of a company to a second wallet associated with a second employee of the company, wherein the token transaction request is issued to recognize accomplishment of the second employee by the first employee; (b) accessing an electronic smart contract and processing the token transaction request of (a) according to the electronic smart contract, the processing comprising: (i) determining a weight associated with the one or more tokens to be transferred; (ii) determining a weighted set of tokens based on the determined weight in (b)(i) and the one or more tokens of (a); (c) decrementing the first wallet by the weighted set of tokens determined in (b)(ii) and incrementing the second wallet by the weighted set of tokens determined in (b)(ii); and (d) recording the token transaction request as a record in a distributed ledger in a blockchain, the record indicating successful token transfer from the first employee to the second employee to recognize accomplishment of the second employee by the first employee.

In yet another embodiment, the present invention provides a system comprising: (a) a first database storing wallet information associated with at least a first wallet associated with a first employee of a company, second wallet associated with a second employee of the company, and a company wallet associated with the company; (b) a second database storing one or more transaction weights; (c) a third database storing at least one electronic smart contract associated with the company; wherein a token transaction request is received to transfer one or more tokens from the first wallet in the first database to the second wallet in the first database, wherein the token transaction request is issued to recognize accomplishment of the second employee by the first employee; wherein the electronic smart contract is accessed from the third database to process the token transaction request according to the electronic smart contract, the processing comprising: (i) determining a weight associated with the one or more tokens to be transferred from the second database; (ii) determining a weighted set of tokens based on the determined weight in (i) and the one or more tokens; and wherein the first wallet in the first database is decremented by the weighted set of tokens determined in (ii) and the second wallet is incremented by the weighted set of tokens determined in (ii).

### BRIEF DESCRIPTION OF THE DRAWINGS

The present disclosure, in accordance with one or more various examples, is described in detail with reference to the following figures. The drawings are provided for purposes of illustration only and merely depict examples of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 shows the time=0 (starting) of exemplary company.

FIG. 2 shows time=1 transaction between employees of exemplary company.

FIG. 3 depicts the transaction and weight matrices at time=1 according to the present invention.

FIG. 4 shows time=2 transactions between employees of exemplary company.

FIG. 5 depicts the transaction and weigh matrices at time=2 according to the present invention.

FIG. 6 depicts a high level diagram of system components in an embodiment.

FIG. 7 depicts an exemplary method between system components.

FIG. 8 depicts a token transfer user interface of ECA.

FIG. 9 depicts a dashboard of the user interface of ECA.

FIG. 10 depicts another dashboard of the user interface of ECA.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein.

An electronic device stores and transmits (internally and/or with other electronic devices over a network) code (composed of software instructions) and data using machine-readable media, such as non-transitory machine-readable media (e.g., machine-readable storage media such as magnetic disks; optical disks; read only memory; flash memory devices; phase change memory) and transitory machine-readable transmission media (e.g., electrical, optical, acoustical or other form of propagated signals—such as carrier waves, infrared signals). In addition, such electronic devices include hardware, such as a set of one or more processors coupled to one or more other components—e.g., one or more non-transitory machine-readable storage media (to store code and/or data) and network connections (to transmit code and/or data using propagating signals), as well as user input/output devices (e.g., a keyboard, a touchscreen, and/or a display) in some cases. The coupling of the set of processors and other components is typically through one or more interconnects within the electronic devices (e.g., busses and possibly bridges). Thus, a non-transitory machine-readable medium of a given electronic device typically stores instructions for execution on one or more processors of that electronic device. One or more parts of an embodiment of the invention may be implemented using different combinations of software, firmware, and/or hardware.

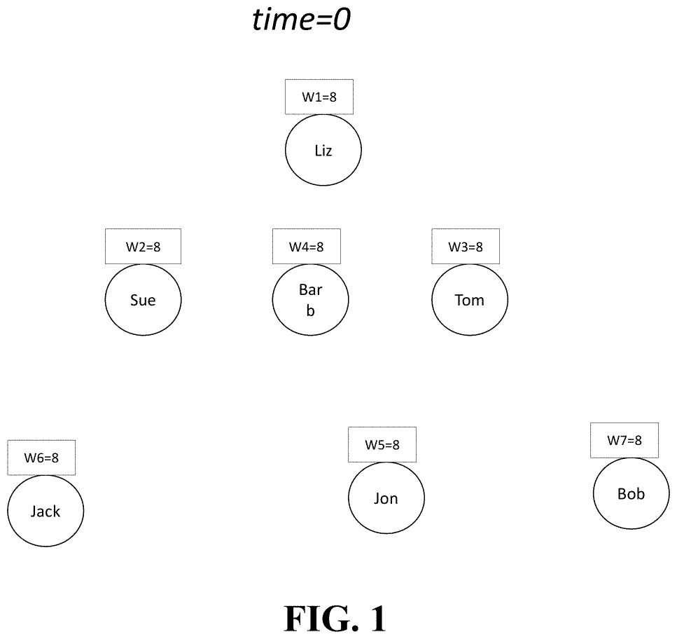

FIG. 1 illustrates an exemplary small company with six employees that will be used to explain in more details the aspects of the aforementioned embodiments. Each employee starts with eight (8) tokens in his/her employee wallet. This wallet is used as the keeper of all tokens. Each wallet has a pair of private and public encryption key pairs. The public key of the wallet is public (known to others), but only the owner of the wallet knows the private key. Each wallet has a wallet ID that is a unique sequence of numbers and letters, which identifies the wallet. The wallet keeps the history of all token transactions associated with that wallet, meaning all the transactions of sending tokens to other wallets, and of receiving tokens from other wallets.

At the beginning (time=0), no token exchange has so far occurred between employees. Each token sender uses the public key of the token receiver's wallet to encrypt the token transaction, which can then be opened only with the token receiver's wallet's private key. The sender of a token may stay anonymous, however the receiver can't be anonymous. In order to send a token, the sender must obtain the public key and wallet ID of the receiver, in which case the receiver can't be kept anonymous.

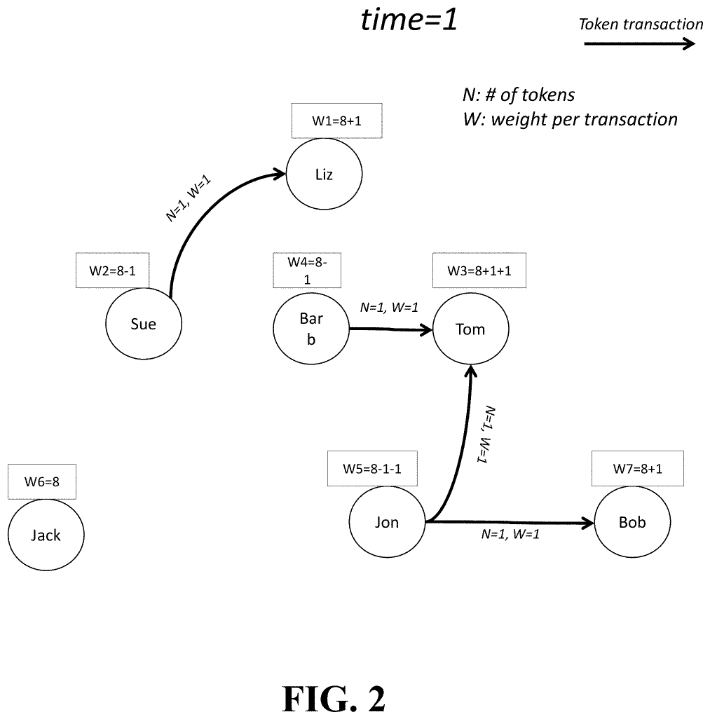

FIG. 2 illustrates the first phase of token transactions between some of the employees illustrated in FIG. 1. Since there is no social networking graph yet, the weights of all transactions are the same and equal to one. Sue sends a token to Liz. Now, Liz has one more token (total of 9 tokens) in her wallet, and Sue has one less (total of 7 tokens) in her wallet. Liz may not know who sent the token. Similarly, Barb sends a token to Tom. Now, Tom has one more (total of 9 tokens) in his wallet, and Barb has one less (total of 7 tokens) in her wallet, and so on. The edges in the graph illustrate each token transaction and marked with the number of tokens and associated weight determined by the system of this invention.

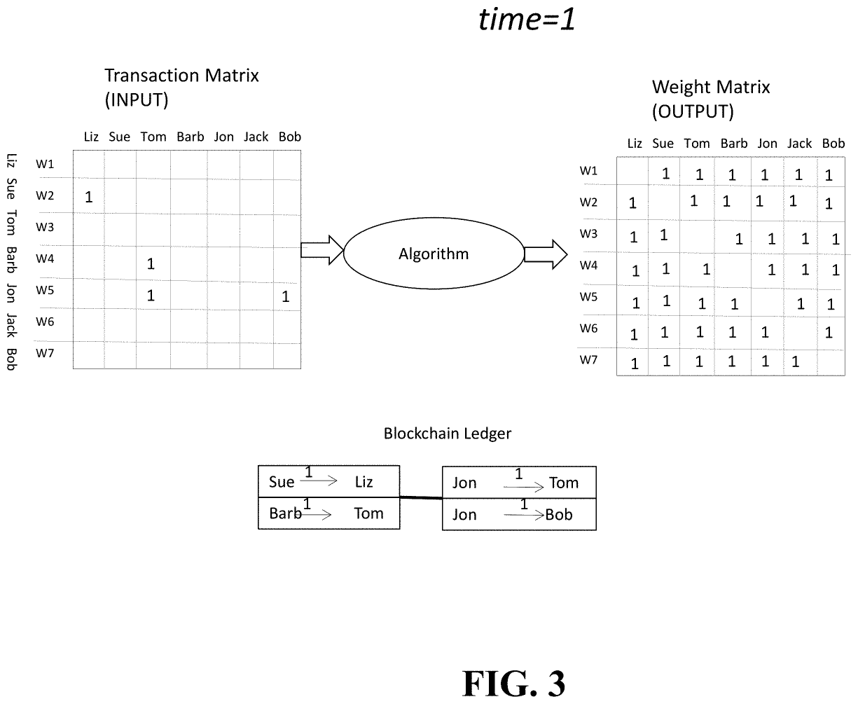

FIG. 3 illustrates a simple transaction matrix corresponding to the graph of FIG. 2 at time=J. The ᵢⱼth entry of the matrix is 1 if there is a transaction from i^{th} wallet to j^{th} wallet, and 0 otherwise. This matrix is an input to the specific algorithm of this invention that derives a corresponding weight matrix (output of the algorithm). The ᵢⱼth entry of the matrix is the weight of the transaction from i^{th} wallet to j^{th} wallet. Note that at this starting point all Wᵢⱼ(t)=1 in the weight matrix, meaning when a token-giver sends one token to a token-receiver, the equivalent transaction is one token.

In FIG. 3, the exemplary blocks in the blockchain are also illustrated. There have been only four token transactions. All transaction weights are 1. Two transactions are assumed to be in a new block. Each transaction record in the block indicates at least the token-receiver, the number of equivalent tokens (weighted), and the token-sender. Now, these transactions are on the blockchain and thus visible by all employees on the ledger/dashboard. Furthermore, each wallet keeps the history of its own transactions.

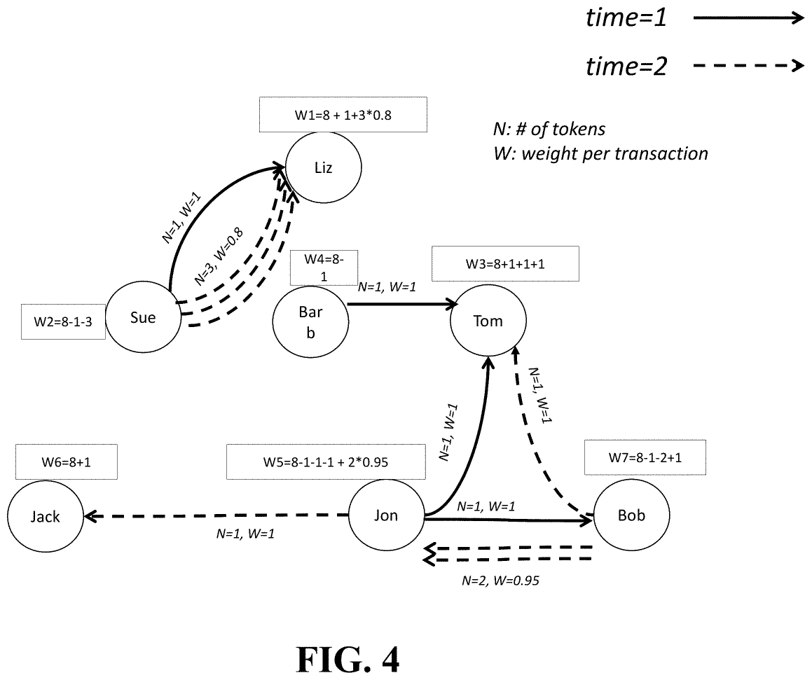

FIG. 4 illustrates additional transactions that occur at a later time (time=2). The previous transactions that occurred at time−1 are drawn with solid lines and the new transactions that occurred at time=2 with dotted lines. Sue sends three new tokens to Liz. Now, Liz has one more token from the previous transaction, and (3×0.8) new tokens from the new transaction in her wallet, while Sue has four tokens remaining in her wallet. Sue has not received any tokens yet. Note that the weight of 0.8 representing the dyad behavior is an exemplary weight of the transaction for merely illustrative purposes (and not based on a real calculation). Similarly, Bob sends two tokens to Jon and one token to Tom. Bob now has five tokens remaining, and so on. The edges in the graph illustrate each token transaction marked with the number of tokens and the associated weight algorithmically determined by the system of this invention.

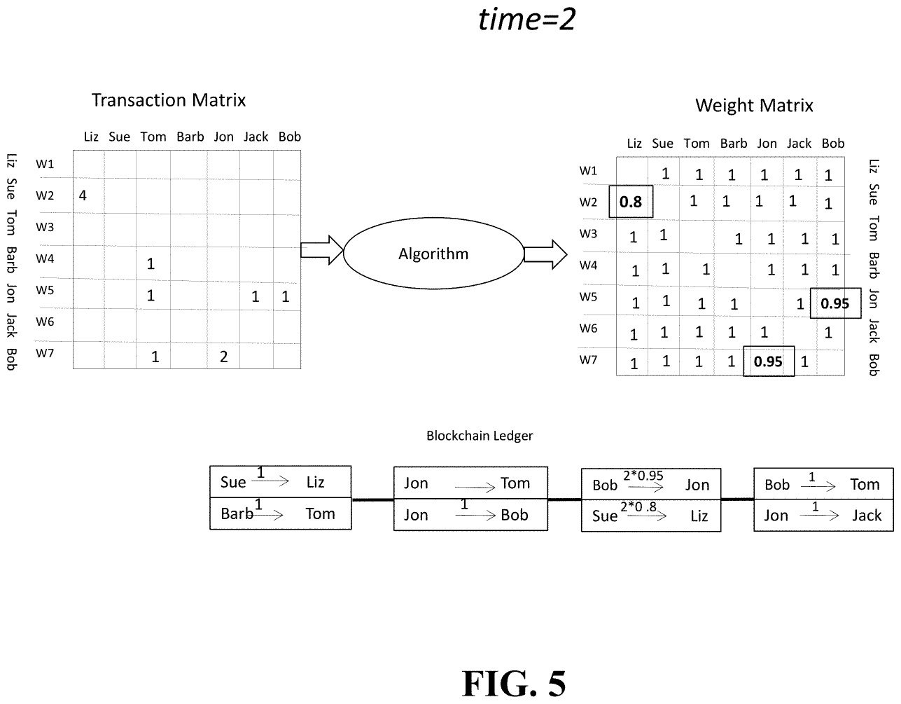

FIG. 5 illustrates the corresponding transaction matrix, weight matrix and the new blocks in the blockchain at time=2. There are four new transactions that are appended to the blockchain. Each transaction shows the transaction details including the weight calculated by the system.

Note that as the social network graph evolves in time, the system of invention updates the weights of token transactions accordingly, and appends the blockchain with new blocks, each block recording a sequence of new transactions. The structure of each block as to how many transactions are recorded as a block and the precise content of each transaction is dependent on the application of the concepts of this invention. Such various possible embodiments are assumed as trivial extensions of the main concepts and assumed covered by this invention.

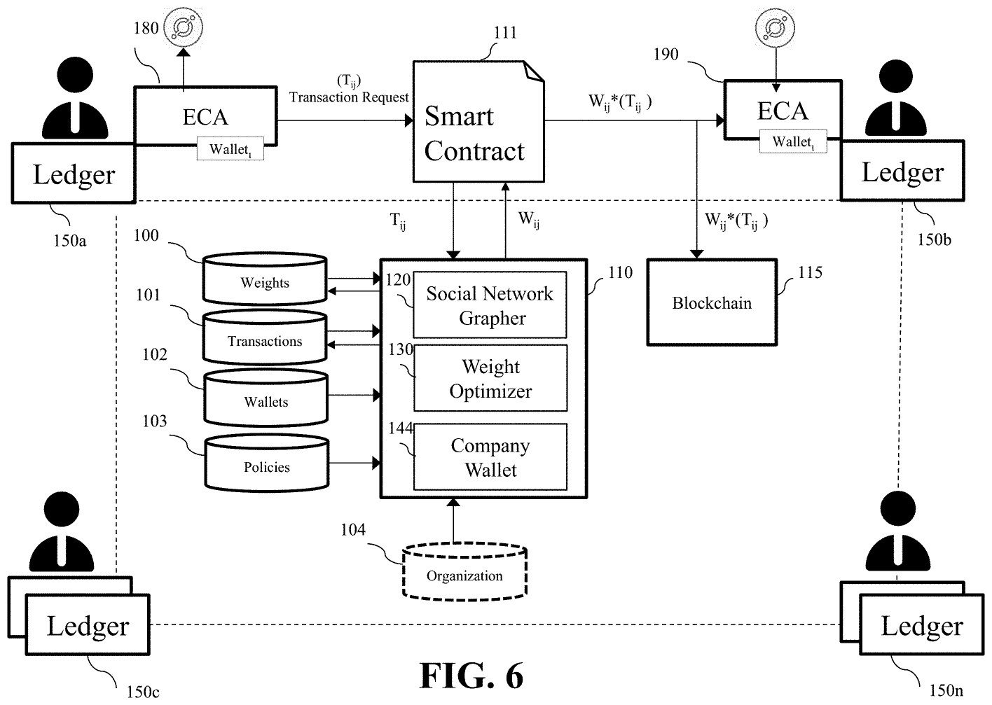

FIG. 6 illustrates a simple block diagram of the system showing key actors, interactions and system components. The token transactions are recorded on a blockchain ledger that is on each employee's computer (also known as nodes) shown as 150a, 150b, 150c, . . . , 150n, which includes a user friendly dashboard. Illustrated in the diagram are Employee i's Client Application (ECA) 180 and electronic wallet, and Employee j's Client Application (ECA) 190 and electronic wallet. ECA is a downloadable or web-based application that allows an employee to send/receive tokens, view the contents of his/her own wallet, and access the dashboard to see information on wallets of his/her colleagues.

In each wallet, the employee has two types of tokens: (i) those received from the company wallet (these are to be sent to other employee wallets), and (ii) those received from other employee wallets (these can or can't be sent to other employee wallets depending on implementation). The tokens in the second category are the employee's performance tokens. Because all transactions are traceable, the differentiation between these two categories can easily be made and the performance tokens can be reported separately from those received directly from the electronic company wallet. The employee may choose not to send any tokens to anyone, to send some of his/her tokens, or to send all his/her tokens. The balance of initial pool of tokens received from the company wallet, received tokens from employees and sent tokens to employees are recorded on the blockchain per wallet since each individual transaction is recorded and immutably stored in a block.

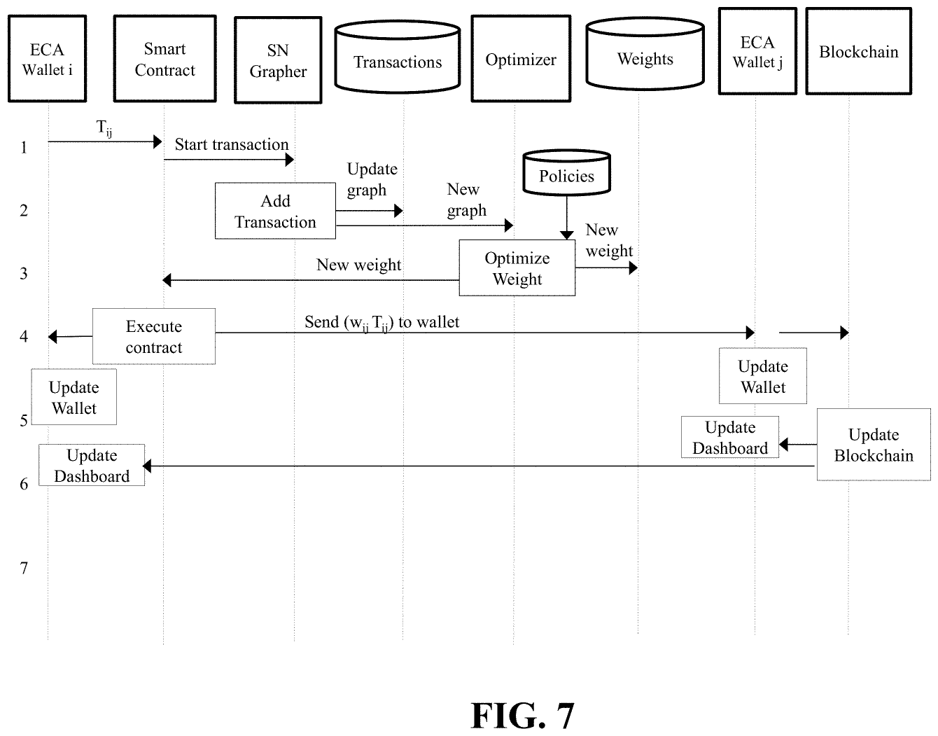

The token transaction request first goes to smart contract 111, which has software code that executes to complete the transaction. Smart Contract 111 checks to determine the weight of the token transaction from employee i to employee j. In order to make the determination, Smart Contract 111 sends the specific transaction to subsystem 110 that has several components. Weights Database 100 contains the most up to date weights of all transactions. Transactions Database 101 contains all the token transaction requests between employees to date that are used to determine the weights. Wallets Database 102 contains the wallet IDs and associated public keys. Policies Database 103 contains specific rules/policies that the company applies to each transaction. This database includes other employee related data as it pertains to token transactions. Subsystem 110 contains company wallet 144 that transfers a number of tokens to each employee wallet according to company policies, and two main software blocks: Social Network Grapher 120 that generates an up to date graph of transactions. It is important to note that the tokens in company wallet are not mined tokens. Weight Optimizer 130 is the main engine of Subsystem 110 that takes the input from various databases such as the policies 103, transactions 101, and updates weights database 100 according to an algorithm. Smart Contract 111 sends a new transaction to Social Network Grapher 120 that updates the transactions matrix in the database and feeds that information to Weight Optimizer 130 for determining the weight associated with aforementioned transaction. Once the new weight is available, Smart Contract 111 completes the transaction, updates wallets 180 and 190 accordingly, and hands over the new transaction to blockchain 115, which adds the new transaction to blockchain. Note that special mining nodes and proof of work that are needed in other public blockchain implementations are not needed in a private blockchain architecture as all nodes are within the company and therefore assumed as trusted nodes. FIG. 7 illustrates the steps of the aforementioned interactions between various components of this invention in chronological order.

Note that these system components and the steps of interactions are simply included to improve the understanding of the concepts of this invention. Many other trivial extensions and implementation variations are possible and covered by this invention.

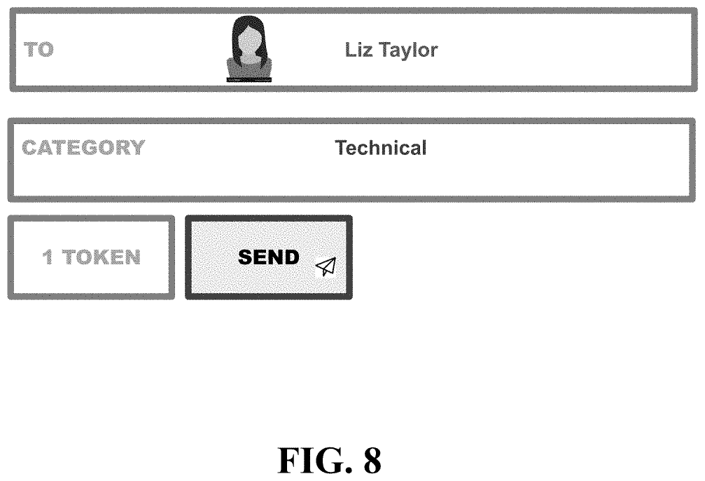

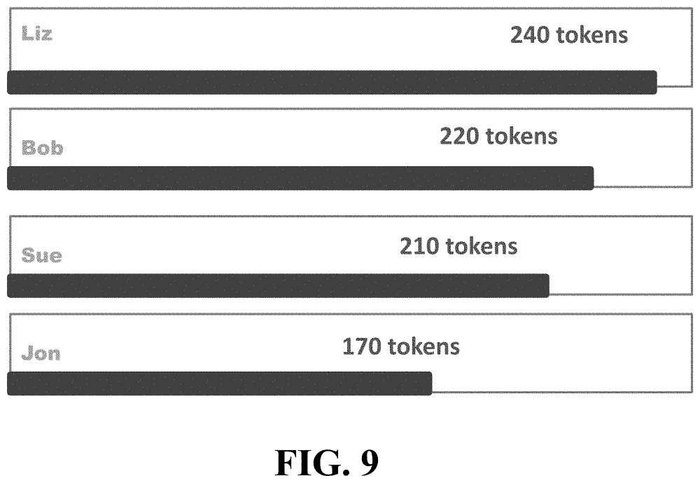

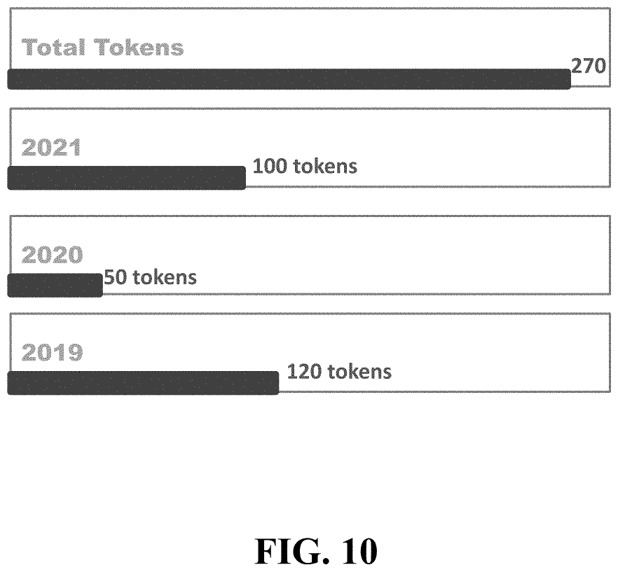

FIG. 8 depicts a simple panel of Employee Client Application 180, which is a software component (a computer program) to send a token reward. This panel is inspired by the email paradigm and can easily be provided via a web page or a using a simple downloadable application. The employee electronic wallet application is a software subcomponent of Employee Client Application 180. FIG. 9 depicts a simple screen of the reward dashboard 150a. FIG. 10 depicts another screen of the dashboard showing the token distribution of the employee by year. These screens are only to improve the understanding of the overall system. Many other trivial alternatives of providing the same functionality are possible, and therefore assumed as covered by this invention.

In one embodiment, the present invention provides a method comprising: (a) receiving a token transaction request to transfer one or more tokens from a first wallet associated with a first employee of a company to a second wallet associated with a second employee of the company; (b) processing the token transaction request of (a), the processing comprising: (i) determining a weight associated with the one or more tokens to be transferred; (ii) determining a weighted set of tokens based on the determined weight in (b)(i) and the one or more tokens of (a); (c) decrementing the first wallet by the weighted set of tokens determined in (b)(ii) and incrementing the second wallet by the weighted set of tokens determined in (b)(ii); wherein the token transaction request is issued to recognize accomplishment of the second employee by the first employee.

In another embodiment, the present invention provides a method comprising: (a) receiving a token transaction request to transfer one or more tokens from a first wallet associated with a first employee of a company to a second wallet associated with a second employee of the company, wherein the token transaction request is issued to recognize accomplishment of the second employee by the first employee; (b) accessing an electronic smart contract and processing the token transaction request of (a) according to the electronic smart contract, the processing comprising: (i) determining a weight associated with the one or more tokens to be transferred; (ii) determining a weighted set of tokens based on the determined weight in (b)(i) and the one or more tokens of (a); (c) decrementing the first wallet by the weighted set of tokens determined in (b)(ii) and incrementing the second wallet by the weighted set of tokens determined in (b)(ii); and (d) recording the token transaction request as a record in a distributed ledger in a blockchain, the record indicating successful token transfer from the first employee to the second employee to recognize accomplishment of the second employee by the first employee.

In yet another embodiment, the present invention provides a system comprising: (a) a first database storing wallet information associated with at least a first wallet associated with a first employee of a company, second wallet associated with a second employee of the company, and a company wallet associated with the company; (b) a second database storing one or more transaction weights; (c) a third database storing at least one electronic smart contract associated with the company; wherein a token transaction request is received to transfer one or more tokens from the first wallet in the first database to the second wallet in the first database, wherein the token transaction request is issued to recognize accomplishment of the second employee by the first employee; wherein the electronic smart contract is accessed from the third database to process the token transaction request according to the electronic smart contract, the processing comprising: (i) determining a weight associated with the one or more tokens to be transferred from the second database; (ii) determining a weighted set of tokens based on the determined weight in (i) and the one or more tokens; and wherein the first wallet in the first database is decremented by the weighted set of tokens determined in (ii) and the second wallet is incremented by the weighted set of tokens determined in (ii).

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor. By way of example, and not limitation, such non-transitory computer-readable media can include flash memory, RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. The computer readable media does not include carrier waves and electronic signals passing wirelessly or over wired connections.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

The various embodiments described above are provided by way of illustration only and should not be construed to limit the scope of the disclosure. Those skilled in the art will readily recognize various modifications and changes that may be made to the to principles described herein without following the example embodiments and applications illustrated and described herein, and without departing from the spirit and scope of the disclosure.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As noted above, particular embodiments of the subject matter have been described, but other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

### CONCLUSION

A system and method have been shown in the above embodiments for the effective implementation of a system and method for tokenized peer recognition factoring-in social behavior. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

1. A method comprising:
(a). receiving a token transaction request to transfer one or more tokens from a first wallet associated with a first employee of a company to a second wallet associated with a second employee of the company;
(b). processing the token transaction request of (a), the processing comprising:
i. determining a weight associated with the one or more tokens to be transferred;
ii. determining a weighted set of tokens based on the determined weight in (b)(i) and the one or more tokens of (a);
(c). decrementing the first wallet by the weighted set of tokens determined in (b)(ii) and incrementing the second wallet by the weighted set of tokens determined in (b)(ii);
wherein the token transaction request is issued to recognize accomplishment of the second employee by the first employee.

2. The method of claim 1, wherein the method further comprises the step of recording the token transaction request as a record in a distributed ledger in a blockchain, the record transindicating successful token transfer from the first employee to the second employee to recognize accomplishment of the second employee by the first employee.

3. The method of claim 1, wherein the step of determining a weighted set of tokens based on the determined weight in (b)(i) and the one or more tokens of (a) comprises determining a weighted set of tokens by multiplying the determined weight in (b)(i) with the one or more tokens of (a).

4. The method of claim 1, wherein the weight associated with one or more tokens to be transferred is derived from a social network graph, with each node in the social network graph being an employee, and an edge between a pair of nodes of the social network graph being a token transaction, with a calculated weight.

5. The method of claim 1, wherein the weight associated with one or more tokens to be transferred is algorithmically determined to penalize clique-ness, friendship, or intra-corporation social behavior that are not pertinent to the second employee's quality of work or performance.

6. The method of claim 1, wherein the first employee receives tokens from a company wallet which may then be transferred to other employees, the company wallet prohibited to receive any tokens from wallets of other employee.

7. The method of claim 1, wherein the first employee receives tokens from both a company wallet and from wallets of other employees of the company, wherein any tokens received from other employees cannot be transferred subsequently to another employee's wallet.

8. The method of claim 1, wherein the weight is a number between zero and one.

9. An article of manufacture comprising a computer usable medium having computer readable program code for performing the method of claim 1.

10. A method comprising:
(a). receiving a token transaction request to transfer one or more tokens from a first wallet associated with a first employee of a company to a second wallet associated with a second employee of the company, wherein the token transaction request is issued to recognize accomplishment of the second employee by the first employee;
(b). accessing an electronic smart contract and processing the token transaction request of (a) according to the electronic smart contract, the processing comprising:
i. determining a weight associated with the one or more tokens to be transferred;
ii. determining a weighted set of tokens based on the determined weight in (b)(i) and the one or more tokens of (a);
(c). decrementing the first wallet by the weighted set of tokens determined in (b)(ii) and incrementing the second wallet by the weighted set of tokens determined in (b)(ii); and
(d). recording the token transaction request as a record in a distributed ledger in a blockchain, the record indicating successful token transfer from the first employee to the second employee to recognize accomplishment of the second employee by the first employee.

11. The method of claim 9, wherein the step of determining a weighted set of tokens based on the determined weight in (i) and the one or more tokens of comprises determining a weighted set of tokens by multiplying the determined weight in (i) with the one or more tokens.

12. The method of claim 9, wherein the weight associated with one or more tokens to be transferred is derived from a social network graph, with each node in the social network graph being an employee, and an edge between a pair of nodes of the social network graph being a token transaction, with a calculated weight.

13. The method of claim 9, wherein the weight associated with one or more tokens to be transferred is algorithmically determined to penalize clique-ness, friendship, or intra-corporation social behavior that are not pertinent to the second employee's quality of work or performance.

14. The method of claim 9, wherein the first employee receives tokens from a company wallet which may then be transferred to other employees, the company wallet prohibited to receive any tokens from wallets of other employee.

15. The method of claim 9, wherein the first employee receives tokens from both a company wallet and from wallets of other employees of the company, wherein any tokens received from other employees cannot be transferred subsequently to another employee's wallet.

16. The method of claim 9, wherein the weight is a number between zero and one.

17. An article of manufacture comprising a computer usable medium having computer readable program code for performing the method of claim 9.

18. A system comprising:
(a). a first database storing wallet information associated with at least a first wallet associated with a first employee of a company, second wallet associated with a second employee of the company, and a company wallet associated with the company;
(b). a second database storing one or more transaction weights;
(c). a third database storing at least one electronic smart contract associated with the company;
wherein a token transaction request is received to transfer one or more tokens from the first wallet in the first database to the second wallet in the first database, wherein the token transaction request is issued to recognize accomplishment of the second employee by the first employee;
wherein the electronic smart contract is accessed from the third database to process the token transaction request according to the electronic smart contract, the processing comprising: (i) determining a weight associated with the one or more tokens to be transferred from the second database; (ii) determining a weighted set of tokens based on the determined weight in (i) and the one or more tokens; and
wherein the first wallet in the first database is decremented by the weighted set of tokens determined in (ii) and the second wallet is incremented by the weighted set of tokens determined in (ii).

19. The system of claim 18, wherein the system further comprises a distributed ledger in a blockchain, the distributed ledger in a blockchain recording the token transaction request as a record, the record indicating successful token transfer from the first employee to the second employee to recognize accomplishment of the second employee by the first employee.

20. The system of claim 18, wherein the weight associated with one or more tokens to be transferred is derived from a social network graph, with each node in the social network graph being an employee, and an edge between a pair of nodes of the social network graph being a token transaction, with a calculated weight.
